(19) United States
(12) Patent Application Publication
(10) Pub. No.: US 2008/0077214 A1
(43) Pub. Date: Mar. 27, 2008

(54) Device and method for cooling animals

(76) Inventor: Robert Stalick, Rockville, MD (US)

Correspondence Address: ARENT FOX LLP, 1050 CONNECTICUT AVENUE, N.W., SUITE 400, WASHINGTON, DC, 20036, US

(21) Appl. No.: 11/902,189

(22) Filed: Sep. 19, 2007

Related U.S. Application Data
(60) Provisional application No. 60/845,523, filed on Sep. 19, 2006.

(51) Int. Cl. A61D 99/00

(52) U.S. Cl. 607/112; 119/850; 607/96

(57) ABSTRACT

A device and method for cooling an animal, operating to reduce heat absorption by reflecting sunshine and heat away from the animal, reducing insulation uptake, and shielding the animal from ultraviolet rays and other radiation, while providing adequate ventilation to support evaporative and/or radiant cooling. An external fabric layer of woven plastic or synthetic stranded material with a metallic coating that provides high reflectivity for a wide bandwidth of radiation is combined with an interior fabric layer capable of rapid evaporation of liquids, which may be moistened artificially or may absorb perspiration for transpiration and cooling effects.

### RELATED APPLICATIONS

This application claims the benefit of U.S. Provisional Application Ser. No. 60/845,523 filed Sep. 19, 2006, titled “Device and Method for Cooling Endothermic Animals,” the entirety of which is incorporated by reference herein.

### BACKGROUND OF THE INVENTION

1. Field of the Invention

The present invention relates to a device and method for cooling endothermic and other animals and, specifically, to a device and method for reducing heat absorbed by animals by using garments made of lightweight materials that are highly reflective and have other characteristics to enhance cooling effects.

2. Background of the Related Art

One problem that exists in the art today is that there are no sufficiently effective devices and methods for cooling endothermic and other animals that would enable significant reduction of heat absorbed by the animals. Animals absorb heat when exposed to the sun, including ultraviolet (UV) radiation, and/or other heat sources, which increases their body temperatures. Many animals have limited abilities to reduce heat. For example, dogs attempt to reduce their body temperature through their paws or by panting. These mechanisms, however, have a limited effect and, as a consequence, dogs tend to overheat when exposed to direct sunlight and avoid participating in outdoor activities.

Although dogs are used as an example throughout the present application, it will be recognized by those skilled in the art that the cooling device and method of the present invention are equally applicable to a variety of animals, including human beings.

Known methods for cooling endothermic and other animals include using the phenomenon of evaporative and/or radiant cooling, achieved by covering an animal with a wet blanket or other moisture-absorbing fabric, or chilling the animal with objects that are mechanically or chemically chilled. One disadvantage of this method is that, if the animal remains in the sunlight, it continues to absorb heat due to the non-reflective qualities of blanket or other moisture-absorbing fabrics and/or most other chilling materials used. Another disadvantage of this method is that the insulation qualities of the blanket or other fabric actually hamper evaporation and can lead to increase in the body temperature of the animal, especially if the animal remains in the sun. Finally, if the moist material used has low insulation qualities, it will dry out very quickly, and would subsequently serve only to increase the body temperature of the animal.

There is a need in the art, therefore, for device(s) and method(s) for cooling endothermic and other animals that reduce the heat absorption of animals by reflecting sunshine and heat away from the body. There is a further need in the art for devices and methods for cooling endothermic and other animals that reduce insulation uptake and shield the animals from the sun's rays, while providing adequate ventilation to support evaporative and/or radiant cooling.

### SUMMARY OF THE INVENTION

The present invention solves the above identified needs, as well as others, by providing devices and methods for cooling endothermic and other animals, which operate to reduce heat absorption by reflecting sunshine and heat away from the body. In addition, the devices and methods of the present invention reduce insulation effects and shield animals from the sun's rays, while providing adequate ventilation to support evaporative and/or radiant cooling.

The devices contemplated by the present invention include a suitable covering for animals that reduces insulation uptake and shields tissues from ultraviolet (UV) radiation, while providing adequate ventilation in support of evaporative and/or radiant cooling. The external layer (interchangeably or alternatively referred to herein as an “outer layer”) of the device, which may be the only layer in some embodiments, may comprise a fabric of woven plastic or synthetic stranded material with a metallic coating, for example, which provides high reflectivity for a broad bandwidth of radiation. Another characteristic of the external layer is openness of weave, with low restriction on movement of air between and through the material fibers and/or other fabric layers. The device may also include an interior layer of a fabric capable of rapid evaporation of liquids. This layer may be wetted artificially or may absorb perspiration for transpiration and cooling effects.

Other objects, features, and advantages will be apparent to persons of ordinary skill in the art from the following description of the invention and the accompanying drawings.

### BRIEF DESCRIPTION OF THE DRAWINGS

In the drawings:

FIG. 1 presents an exemplary material for use in conjunction with one embodiment of a device and method for cooling of endothermic and other animals of the present invention;

FIG. 2 presents an exemplary structure of a device for cooling endothermic and other animals used in conjunction with one embodiment of the present invention;

FIG. 3 presents one exemplary embodiment of a device for cooling endothermic and other animals used in conjunction with one embodiment of the present invention;

FIGS. 4A-4C show another exemplary embodiment of the device for cooling endothermic and other animals used in conjunction with one embodiment of the present invention; and

FIGS. 5A-5C show yet another exemplary embodiment of the device for cooling endothermic and other animals used in conjunction with one embodiment of the present invention.

### DETAILED DESCRIPTION

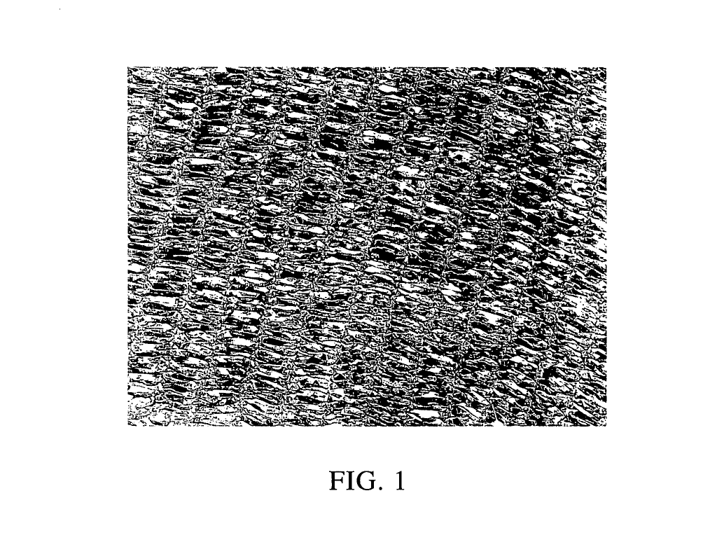

Referring now to FIG. 1, therein shown is an exemplary material for use in conjunction with one embodiment of the device and method for cooling of endothermic and other animals of the present invention. In this embodiment, the material comprises a fabric of woven plastic with a metallic coating that provides a high reflectivity for a wide bandwidth of radiation. It will be recognized by those of ordinary skill in the art, however, that any lightweight material with a high-reflectivity coating, such as Mylar®, may be used. In the embodiment shown in FIG. 1, for example, strands of the fabric comprised of woven plastic with a metallic reflective coating are bonded at, e.g., 1-inch intervals. It will be recognized by those of ordinary skill in the art, however, that linear or twisted fabric strands may be used, and that bonding may be accomplished by heat-bonding, thread-bonding, or any other suitable method for connecting the fabric strands together at regular and/or irregular intervals may be used. It will further be recognized by those of ordinary skill in the art that crossed or otherwise woven strands may be used, and that the strands may be bonded at variable intervals, as long as the overall goal of providing porous material that has the qualities of being lightweight and reflective of light is achieved.

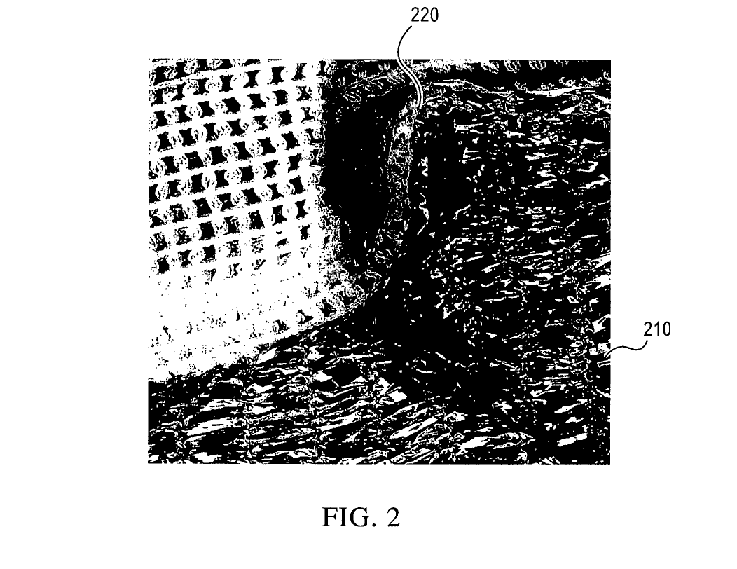

In one embodiment, the fabric used may be a highly reflective coating deposited on a lightweight fabric, as shown in FIG. 2, for example. In the embodiment shown in FIG. 2, an inner layer 220 of lightweight fabric is added to an outer layer 210, such as that described above in conjunction with FIG. 1. The material of the outer layer 210 may be a weave of plastic and/or metallized strands, a metal-coated synthetic fiber, or other light-reflective material. Metal coating that may be utilized to enhance reflectivity includes materials made with nickel, copper, aluminum, silver, gold, and/or combinations thereof, among others. To increase the cooling effect of a garment comprising this two-layered material, a fabric capable of rapid evaporation of liquids, for example, may be used for the inner layer 220. The inner layer 220 may be artificially moistened to increase the cooling effect, or may absorb perspiration for transpiration and cooling purposes. The inner layer may be made of cotton or any other fabric that provides rapid wicking and evaporative cooling. Those of ordinary skill in the art will recognize, however, that the inner layer may be made of any lightweight fabric, such as mesh or netting of natural or synthetic fiber that is capable of rapid evaporation of liquids. The inner and outer layers may be joined, for example, through sewing or other mechanism for fastening the layers together. Furthermore, edge binding may be used to cover the edges and reinforce the seams.

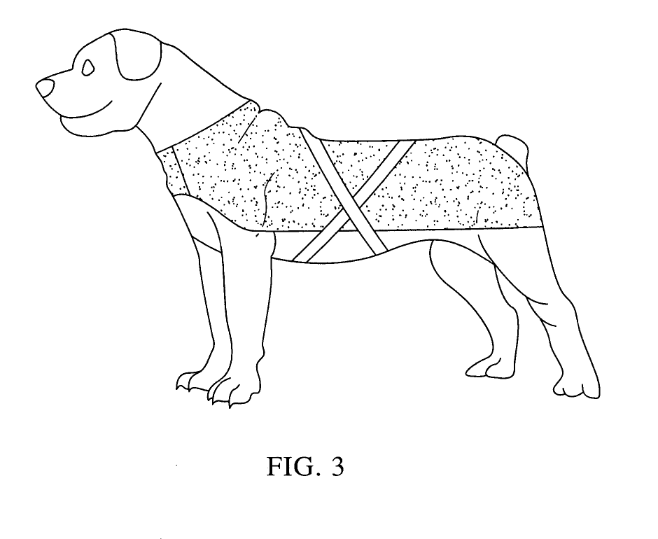

Referring now to the embodiment shown in FIG. 3, the material described above with respect to FIG. 1, for example, is used in to create the reflective dog jacket shown in FIG. 3, or other garment. The dog jacket may be held in place, for example, via a band, which crosses in from of the animal's neck and fastened by hook and loop fasteners, for example. To enhance reflection of heat and cooling, the garment should be loose-fitting, so that natural gaps occur with the movement of the animal. In addition, some lift of the garment is desirable, in order to prevent continuous contact between the garment and the animal. In the case of dogs, for example, the dog's fur creates a gap for purposes of preventing continuous contact.

The dog jacket illustrated in FIG. 3 may be fastened via elastic straps that extend from the sides of the jacket, cross under the belly of the animal, and are fastened to the opposite side of the jacket. The fastening may be achieved either through mechanical or hook-and-loop fasteners, for example. In one embodiment, to retain the position of the jacket on the rear of the animal, padded elastic loops may be built into the back end of the jacket, which encircle the rear legs. It will be recognized by those of ordinary skill in the art, however, that any type of garment and any type of fastening mechanism may be used as long as the fabric used to make it is lightweight and highly reflective, similar to the one described in connection with FIG. 1.

If the dog jacket comprises two or more layers, the layers may be mechanically laminated together through stitches, and bound at the edges with supportive and protective material, for example. The dog jacket may be held in place with a band that crosses in front of the neck, fastened by hook and loop fasteners. Various forms of chest and belly fastening may be used. For example, a flap may run from the neck between the legs to a girth strap that joins the sides of the chest flap across the back. The external layer of laminated reflective covering may attach to the sides with hook and loop, for example. A chest flap may provide chest protection for dogs working in heavy grass and brush. A girth strap may be provided to ensure retention during use in rough conditions. Another fastening mechanism that may be used is a girth strap of stretch material that may run from one side of the jacket to the other, fastened via a hook and loop mechanism, for example.

Experimental results from the use of an embodiment of the dog jacket of the present invention will now be described. The uncovered coat temperatures of dark brown or dark gray-coated dogs in certain conditions that included ambient temperature of about 90° Fahrenheit, were about 130°-140° Fahrenheit, measured with an infrared reflective thermometer. Under the same conditions, the coat temperatures were reduced to around 100° Fahrenheit upon providing the dogs with a two-layered dog jacket, the outer layer comprised of Mylar®, the inner of light cotton mesh, unmoistened. When provided with this dog jacket, the behavior of the dogs changed dramatically, as the dogs stopped avoiding going out into the sun. When performed in dry, high altitude conditions, the same experiment resulted in a drop in a dog's coat temperature from 130° to 80° Fahrenheit.

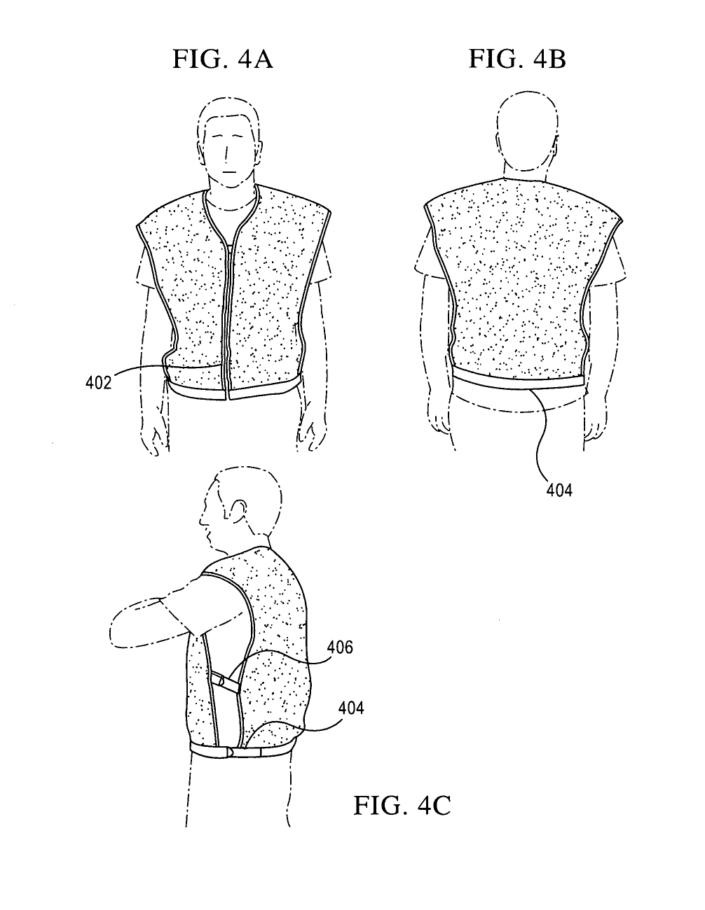

Referring now to FIGS. 4A-4C, therein shown is an embodiment of the present invention, depicted in front, back and side views, respectively, for use by humans. The garment of this embodiment, may be a one- or two-layer garment, as described in detail above, and may be fastened by a zipper 402, a strap 406, a belt 404, a combination thereof, or any other appropriate garment-fastening devices, such as buckles or buttons. While the embodiment shown in FIGS. 4A-4C depicts a sleeveless vest, it will be recognized by those of ordinary skill in the art that the present invention may be used in conjunction with any known garment, such as sweater, pants, and jumpsuit, for example.

The vest may comprise an outer reflective layer and may include a lining of synthetic wicking material. An unlined vest or jacket may be used primarily as a covering over existing clothing.

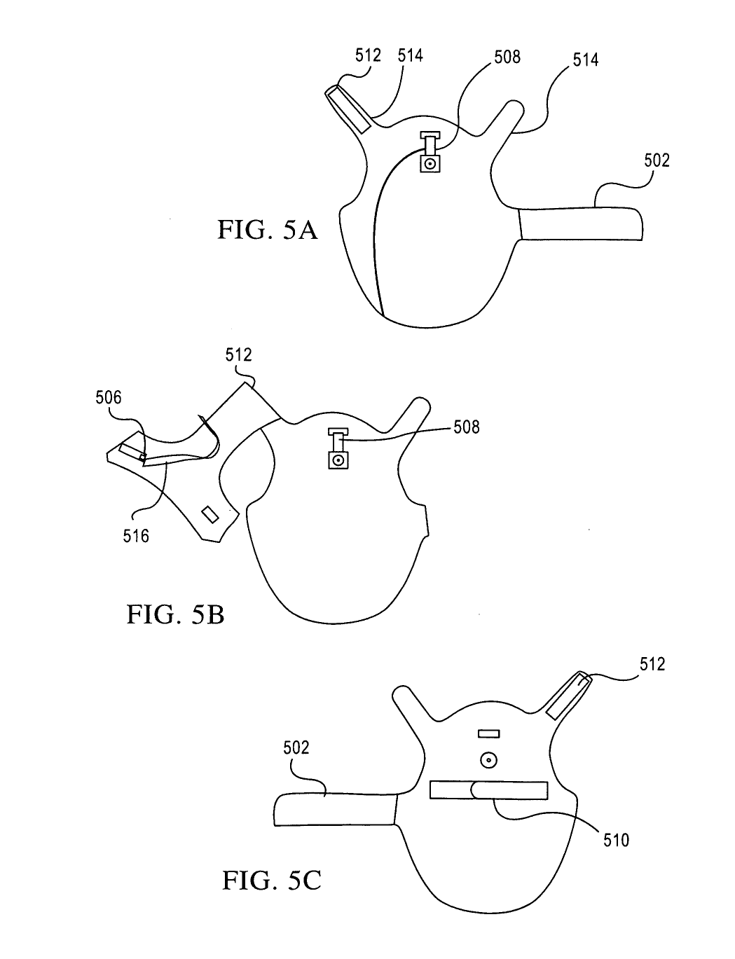

Referring now to FIG. 5A, therein shown is another exemplary garment for use by dogs, in accordance with one embodiment of the present invention. Straps 514 may be fastened under the neck of a dog, for example by use of Velcro® 512 for fastening. Chest strap 502 may be used for fastening the garment under a dog's chest, for example. In accordance with one embodiment, a leash strap 508 may be attached to the garment. It will be recognized by those of ordinary skill in the art that the garment of this embodiment may have any shape that is appropriate for a dog, and/or may be fastened by various straps, belts, zippers, or other fastening devices, as appropriate.

Referring now to the embodiment shown in FIG. 5B, chest protection flap 506 may be provided with the garment to ensure protection of dogs working in heavy grass, brush or other rough conditions. A girth strap 516 and a leash strap 508, may also be provided.

Referring now to FIG. 5C, therein shown is an embodiment of the present invention that includes a harness 510, which may ensure secure fastening of the garment, for example.

It will be recognized by those of ordinary skill in the art that the device of the present invention may be used for cooling any endothermic or other animal. For cooling horses, for example, a jacket similar to the dog jacket may be provided, but the inner lining material may be a finer mesh of synthetic material to protect the horse from biting insects. The fastening of the horse jacket may envelop the neck, almost reaching the ears of the animal, and may be held fast with elastic adjustments on the underside. The back covering may be held in place by crossing girth straps, fastened by common safety release clips, commonly used in horse clothing, for example.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein.

1. A device for cooling an animal, the device comprising:
an external layer of stranded material, the external layer having a radiation-reflective feature and an open weave;
an inner layer for evaporative cooling; and
at least one fastening mechanism;
wherein the external layer and the inner layer are joined together;
wherein the at least one fastening mechanism is used to fasten the joined external layer and inner layer to the animal; and
wherein the external layer reflects radiation from the animal.

2. The device of claim 1, wherein the radiation-reflective feature is a metallic coating.

3. The device of claim 1, further comprising:
a chest flap.

4. The device of claim 1, wherein the inner layer comprises cotton mesh.

5. The device of claim 1, wherein the inner layer comprises synthetic wicking mesh.

6. The device of claim 1, wherein the inner layer absorbs perspiration of the animal.

7. The device of claim 1, wherein the at least one fastening mechanism is selected from a group consisting of a zipper, a strap, a hook and loop fastener, and a band.

8. The device of claim 1, further comprising:
a harness; and
a leash strap.

9. A method for cooling an animal, the method comprising:
providing an external layer of stranded material, the external layer having a radiation-reflective feature and an open weave;
providing an inner layer for evaporative cooling;
joining the external layer and the inner layer; and
fastening the joined external layer and inner layer to the animal via an at least one fastening mechanism;
wherein the external layer reflects radiation away from the animal.

10. The method of claim 9, wherein the radiation-reflective feature is a metallic coating.

11. The method of claim 9, further comprising:
providing a chest flap.

12. The method of claim 9, wherein the inner layer comprises cotton mesh.

13. The method of claim 9, wherein the inner layer comprises synthetic wicking mesh.

14. The method of claim 9, wherein the inner layer absorbs perspiration of the animal.

15. The method of claim 9, wherein the at least one fastening mechanism is selected from a group consisting of a zipper, a strap, a hook and loop fastener, and a band.
